(19) United States
(12) Patent Application Publication
(10) Pub. No.: US 2025/0051941 A1
(43) Pub. Date: Feb. 13, 2025

(54) BISMUTH-COPPER SINGLE ATOM ALLOY MATERIAL, AND PREPARATION METHOD AND APPLICATION THEREOF

(71) Applicant: DALIAN INSTITUTE OF CHEMICAL PHYSICS, CHINESE ACADEMY OF SCIENCES, Dalian, Liaoning (CN)

(72) Inventors: Fuxiang ZHANG, Dalian, Liaoning (CN); Yucheng CAO, Dalian, Liaoning (CN)

(21) Appl. No.: 18/681,611

(22) PCT Filed: Jun. 28, 2023
(86) PCT No.: PCT/CN2023/103077

§ 371 Date: Feb. 6, 2024

(30) Foreign Application Priority Data
Nov. 28, 2022 (CN) 202211506397.2

(51) Int. Cl. C25B 11/089; C25B 3/26; C25B 11/037; C25B 11/065

(52) U.S. Cl. CPC C25B 11/089; C25B 3/26; C25B 11/037; C25B 11/065

(57) ABSTRACT

The present invention discloses a bismuth-copper single-atom alloy catalyst, a preparation method and an application thereof. The catalyst includes copper nanoparticles and bismuth atoms. The copper nanoparticles are of a polycrystalline structure, and the bismuth atoms are dispersed in the copper nanoparticles in a single-atom form. The catalyst is prepared by means of thermal decomposing the metal complex and the followed in-situ electroreduction. The preparation method of the bismuth-copper single-atom alloy catalyst of the present invention is simple to operate, and the single-atom bismuth content is adjustable. The single-atom bismuth content can be adjusted by changing reaction conditions. By means of loading mutually isolated bismuth atoms on the copper nanoparticles, the electronic state of copper atoms is adjusted, such that an ability of bismuth-copper single-atom alloy to catalyze carbon-carbon coupling is improved, so as to obtain a higher selectivity of electrocatalytically reducing carbon dioxide to a multi-carbon product, providing a new way for efficient conversion of carbon dioxide.

### TECHNICAL FIELD

The present disclosure relates to the technical field of electrocatalyst preparation, and particularly relates to a bismuth-copper single-atom alloy material, and a preparation method and application thereof.

### BACKGROUND ART

In recent years, use of fossil fuels has caused massive emission of carbon dioxide that is greenhouse gas. This situation has further triggered a series of problems of energy shortage and climate change. The above problems can be effectively solved by converting carbon dioxide into high value-added chemicals. In various ways of converting carbon dioxide, electrocatalytic reduction of carbon dioxide can be coupled with renewable energy, which is one of the most promising ways.

However, during electrocatalytic reduction of carbon dioxide, not only side reaction of hydrogen evolution occurs, but also many reduction products are generated. In various reduction products, multi-carbon products (such as ethylene and ethanol) have gained wide attention because of their diversified applications in chemical and energy industries. Therefore, it is one of current research hotspots to design and synthesize catalysts having high selectivity for the multi-carbon products.

Metallic copper is the only catalyst capable of directly reducing carbon dioxide to a high value-added multi-carbon compound under high current efficiency and selectivity due to its moderate adsorption capacity of carbon monoxide and hydrogen. Although some headway has been made in research on copper catalysts, it is still a current research goal to develop new strategies to improve selectivity of multi-carbon products.

Single-atom catalysts have been widely developed because of their maximum atomic use ratio and comprehensive advantages of homogeneous and heterogeneous catalysis. Single-atom alloy catalysts in which one metal is distributed in another base metal in a low-concentration single-atom form, as a special single-atom catalyst, have attracted people's attention. Better catalytic performance can be obtained advantageously through an adjustment effect of single-atom doped metal on an electronic structure of the base metal or a possible synergistic effect between different metals. At present, single-atom alloy catalysts are generally used in a traditional catalytic direction, and have not been used to electrocatalytically reduce carbon dioxide so as to prepare a multi-carbon product.

Based on the above research status, it is of great significance to find a simple method for preparing a single-atom alloy catalyst and to use the single-atom alloy catalyst to electrocatalytically reduce carbon dioxide so as to prepare a multi-carbon product.

### SUMMARY

In order to solve the above technical problems, the present disclosure provides a bismuth-copper single-atom alloy catalyst, and a preparation method and application thereof. The single-atom alloy catalyst is used in electrocatalytic reduction reaction of carbon dioxide, such that selectivity of electrochemically reducing carbon dioxide to a multi-carbon product can be improved, and an application field of single-atom alloy is expanded.

To achieve the above objective, the present disclosure uses the following technical solutions:

An aspect of the present disclosure provides a bismuth-copper single-atom alloy catalyst, including copper nanoparticles and bismuth atoms. The copper nanoparticles are of a polycrystalline structure. The bismuth atoms are dispersed in the copper nanoparticles in a single-atom form.

In the above technical solution, further, the bismuth atoms account for 0.9%-6.5% of a total mass of the single-atom alloy.

In the above technical solution, further, a diameter of the copper nanoparticles is 5 nm-20 nm.

Another aspect of the present disclosure provides a method for preparing the single-atom alloy catalyst mentioned above. The method includes the following steps of:
(1) mixing a soluble copper salt with water, followed by adding thiourea to react, and then washing, centrifuging and drying a reactant after reaction to obtain a precursor A;
(2) mixing a soluble bismuth salt with water, followed by adding sodium diethyldithiocarbamate to react, and then washing, centrifuging and drying a reactant after reaction to obtain a precursor B;
(3) ultrasonically dispersing the precursor A and the precursor B in an alcohol solvent, and obtaining a mixed solution;
(4) heating the mixed solution obtained in step (3) to reflux, then washing, centrifuging and drying a product after reaction, and obtaining a copper sulfide precursor compounded with single-atom bismuth; and
(5) applying the copper sulfide precursor compounded with single-atom bismuth obtained in step (4) to a carbon material as an electrode to perform electrochemical reduction, and obtaining the bismuth-copper single-atom alloy catalyst.

In the above technical solution, further, the soluble copper salt includes either of copper dichloride and copper dichloride hydrate.

A molar ratio of the soluble copper salt to the thiourea is 1:(0.5-2), and preferably 1:1. A reaction time is not less than 10 s.

In the above technical solution, further, the soluble bismuth salt is bismuth nitrate.

A molar ratio of the soluble bismuth salt to the sodium diethyldithiocarbamate is 1:(1-4), and preferably 1:3. A reaction time is not shorter than 1 min.

In the above technical solution, further, a mass ratio of the precursor A to the precursor B is 5:(1-5).

The alcohol solvent includes ethylene glycol. A mass ratio of the ethylene glycol to the precursor A is (33-55):50.

In the above technical solution, further, the heating reflux is conducted at a temperature of 120° C.-130° C. for 0.5 h-4 h.

In the above technical solution, further, the copper sulfide precursor compounded with single-atom bismuth is applied to the carbon material through dripping or spraying.

The carbon material includes any one of glassy carbon electrode, carbon paper, and carbon cloth.

The electrode is a working electrode or a cathode.

An electrolyte for the electrochemical reduction is potassium bicarbonate or potassium hydroxide. A concentration of the electrolyte is 0.1 M-1 M. An electroreduction potential range is −0.8 V vs. RHE to −1.1 V vs. RHE. An electroreduction reaction time is 10 min-30 min.

Another aspect of the present disclosure provides application of the bismuth-copper single-atom alloy material mentioned above in electrochemical reduction reaction of carbon dioxide.

The present disclosure has the following beneficial effects:

1. Compared with the prior art, the bismuth-copper single-atom alloy catalyst according to the present disclosure has a specific structure. The bismuth atoms are distributed on surfaces and bulk phases of the copper nanoparticles in a single-atom form. By means of loading mutually isolated bismuth atoms on the copper nanoparticles, an electronic state of copper atoms is adjusted, such that an ability of bismuth-copper single-atom alloy to catalyze carbon-carbon coupling is improved, so as to obtain a higher selectivity of electrocatalytically reducing carbon dioxide to a multi-carbon product, providing a new way for efficient conversion of carbon dioxide.

2. The method for preparing the bismuth-copper single-atom alloy catalyst according to the present disclosure is simple to operate, and a content of the single-atom bismuth can be adjusted by changing reaction conditions, such that catalytic performance is adjusted.

3. The bismuth-copper single-atom alloy catalyst according to the present disclosure can be used to electrocatalytic reduce carbon dioxide so as to prepare a multi-carbon product.

However, a single-atom alloy catalyst prepared through the prior art may be only used to prepare a mono-carbon product. Specifically, the single-atom alloy catalyst according to the present disclosure enables selectivity of the multi-carbon product to reach 73.4%.

### BRIEF DESCRIPTION OF THE DRAWINGS

In order to more clearly illustrate the technical solution in the embodiment of the present invention or the prior art, the following is a brief introduction of the accompanying drawings required to be used in the description of the embodiment or the prior art. Obviously, the accompanying drawings in the description below are some embodiments of the present invention. For those ordinary in the art, other accompanying drawings can also be obtained from these accompanying drawings without creative labor.

FIG. 1 shows a high-angle annular dark-field image that the metallic single-atom bismuth is mono-dispersed on copper nanoparticles according to Example 1 of the present disclosure;

FIG. 2 shows a high-angle annular dark-field image that the metallic single-atom bismuth is mono-dispersed on copper nanoparticles according to Example 2 of the present disclosure;

FIG. 3 shows a high-angle annular dark-field image that the metallic single-atom bismuth is mono-dispersed on copper nanoparticles according to Example 3 of the present disclosure; and

FIG. 4 shows a Faradaic efficiency-potential curve of catalyzing electroreduction reaction of carbon dioxide to prepare a multi-carbon product in an H-type electrolytic cell by a bismuth-copper single-atom alloy catalyst.

### DETAILED DESCRIPTION OF THE EMBODIMENTS

The following non-limiting examples can enable those of ordinary skill in the art to fully understand the present invention, but do not limit the present invention in any way.

Sources of all raw materials of the present disclosure are not particularly limited. The raw materials both obtained commercially and prepared according to conventional methods familiar to those skilled in the art meet the requirements of the present invention.

Purity of all the raw materials of the present disclosure is not particularly limited. The analytically pure raw materials are preferably used in the present disclosure.

To make the objectives, technical solutions, and advantages of the present invention clearer, the following clearly and completely describes the technical solutions in the embodiments of the present invention with reference to the accompanying drawings in the embodiments of the present invention. Apparently, the described embodiments are merely some rather than all of the embodiments. The following description of at least one exemplary embodiment is actually only illustrative, and is in no way serves as any limitation on the present invention and its application or use. Based on the embodiments of the present invention, all the other embodiments obtained by those of ordinary skill in the art without inventive effort are within the protection scope of the present invention.

It should be noted that the terms used herein are only intended to describe specific embodiments and are not intended to limit the exemplary embodiments of the present disclosure. In addition, for the numerical ranges in the present disclosure, it should be understood that each intermediate value between the upper and lower limits of the range is also specifically disclosed. Any stated values or intermediate values within a stated range, as well as smaller ranges between any other stated values or the intermediate values within the stated values, is also included in the present disclosure. The upper and lower limits of these smaller ranges can be included or excluded independently from the range. Unless otherwise specified, all technical and scientific terms used herein have the same meaning as generally understood by those skilled in the art described in the present disclosure. Although the present disclosure only describes preferred methods and materials, any methods and materials similar or equivalent to those described herein can also be used in the implementation or testing of the present disclosure. In addition, it should also be understood that the terms “include”, “comprise”, “have”, “contain”, and the like used herein are all open-ended terms, meaning including but not limited to.

### Example 1

Bismuth-copper single-atom alloy was prepared as follows:

(1) Copper chloride and thiourea were each dissolved in 50 mL of water to obtain a thiourea aqueous solution and a copper chloride aqueous solution with a concentration of 0.1 M, respectively. The thiourea aqueous solution was added into the copper chloride aqueous solution to react. After reacting for one minute, a precursor A was obtained by means of centrifuging, washing, and drying a reactant.

(2) Bismuth nitrate and sodium diethyldithiocarbamate were each dissolved in 50 mL of water to obtain a bismuth nitrate solution and a sodium diethyldithiocarbamate solution with a concentration of 0.1 M, respectively. The bismuth nitrate solution was added into the sodium diethyldithiocarbamate solution to react. After reacting for one hour, a precursor B was obtained by means of centrifuging, washing, and drying a reactant.

(3) 50 mg of precursor A and 30 mg of precursor B were taken and ultrasonically dispersed in 40 mL of ethylene glycol to obtain a dispersion liquid. The dispersion liquid was placed in an oil bath and subjected to refluxing at 120° C. for 2 hours, and then was naturally cooled to a room temperature to obtain a product. The product was centrifuged, and then was washed repeatedly with ethanol and water, followed by centrifugal drying to obtain a copper sulfide precursor compounded with single-atom bismuth.

(4) 2 mg of the copper sulfide precursor compounded with single-atom bismuth was taken and ultrasonically dispersed in 0.5 mL of ethanol, followed by adding 5 μL of alcohol solution of perfluorinated sulfonic acid resin to obtain a mixed solution. After uniform mixing, 5 μL of the mixed solution was dropped on a surface of a glassy carbon electrode as a working electrode, a platinum electrode was taken as an anode, and a silver/silver chloride electrode was taken as a reference electrode. By applying a potential of −0.9 V (relative to RHE), in-situ electroreduction was conducted in a 0.1 M potassium bicarbonate solution for 10 min with the electrodes, and a bismuth-copper single-atom alloy catalyst was obtained.

After testing, a mass fraction of single-atom bismuth in the bismuth-copper single-atom alloy catalyst obtained in the example was 3.7%.

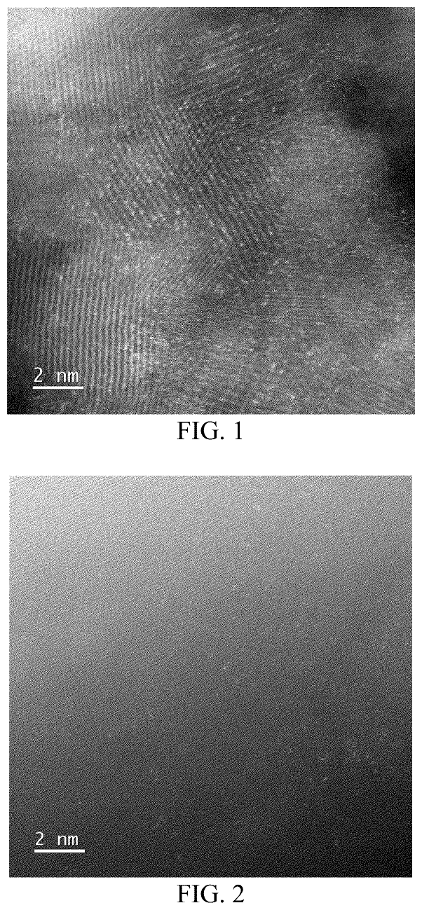

As shown in FIG. 1, the high-angle annular dark-field image proves that the obtained sample was that the single-atom bismuth mono-dispersed on the copper nanoparticles.

### Example 2

The preparation method was similar to Example 1 and different in that reflux time in step (3) was 1.5 hours.

After testing, a mass fraction of single-atom bismuth in the bismuth-copper single-atom alloy catalyst obtained in the example was 2.2%.

As shown in FIG. 2, the high-angle annular dark-field image proves that the obtained sample was that the single-atom bismuth mono-dispersed on the copper nanoparticles.

### Example 3

The preparation method was similar to Example 1 and different in that a mass of the precursor A in step (3) was 50 mg.

After testing, a mass fraction of single-atom bismuth in the bismuth-copper single-atom alloy catalyst obtained in the example was 6.5%.

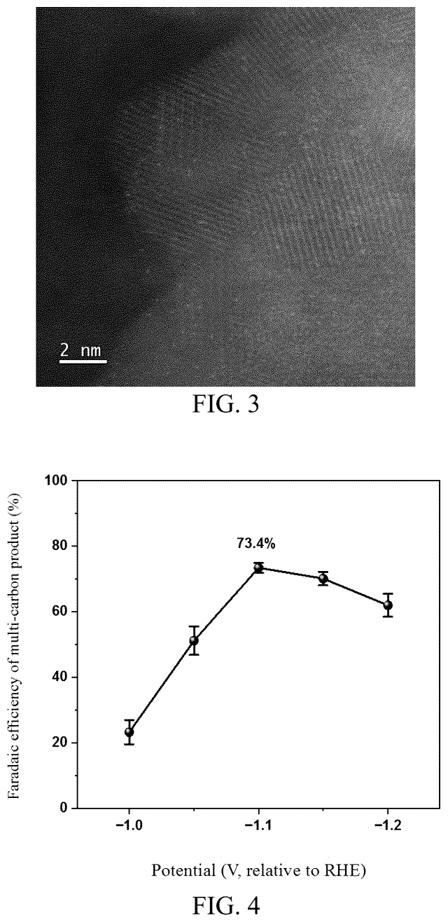

As shown in FIG. 3, the high-angle annular dark-field image proves that the obtained sample was the single-atom bismuth mono-dispersed on the copper nanoparticles.

### Example 4

Electrocatalytic reduction performance of the single-atom alloy catalyst for carbon dioxide was tested.

Catalytic performance of the single-atom alloy catalyst prepared in Example 1 of the present disclosure in electrocatalytic reduction reaction of carbon dioxide was tested.

A glassy carbon electrode loaded with the single-atom alloy catalyst obtained in Example 1 of the present disclosure was taken as a working electrode, a platinum electrode as a counter electrode, and a silver/silver chloride electrode as a reference electrode. 0.1 M potassium bicarbonate solution was taken as an electrolyte. Electroreduction performance of carbon dioxide was tested in an H-type electrolytic cell. A flow rate of carbon dioxide was kept at 10 sccm in the testing process. A constant potential method was used in the test, and an applied potential range was −1.0 V to −1.2 V (relative to RHE). A gas phase product of the reaction was detected with gas chromatography, and a liquid phase product was detected with nuclear magnetic resonance hydrogen spectroscopy.

As shown in FIG. 4, selectivity of the bismuth-copper single-atom alloy catalyst prepared in Example 1 in electrocatalytically reducing carbon dioxide at different potentials so as to prepare a multi-carbon product can be up to 73.4%.

Finally, it should be noted that the above embodiments are only used to illustrate the technical solutions of the present invention, but not to limit them; although the present invention has been described in detail with reference to the foregoing embodiments, those ordinarily skilled in the art should understand that: the technical solutions described in the foregoing embodiments can still be modified, or some or all of the technical features thereof can be equivalently replaced; and these modifications or replacements do not make the essence of the corresponding technical solutions deviate from the scope of the technical solutions of the embodiments of the present invention.

For any person skilled in the art, without departing from the scope of the technical solution of the present disclosure, many possible variations and modifications can be made to the technical solution of the present disclosure using the technical content disclosed above, or it can be modified into equivalent embodiments with equivalent changes. Therefore, any simple modifications, equivalent changes, and modifications to the above embodiments based on the technical essence of the present disclosure that do not deviate from the technical solution of the present disclosure should still fall within the scope of protection of the technical solution of the present disclosure.

The above is only some preferred embodiments of the present invention. It should be noted that for ordinary skilled in the art, several improvements and embellishments can be made without departing from the principles of the present disclosure. These improvements and embellishments should also be considered as the scope of protection of the present invention.

1. A bismuth-copper single-atom alloy catalyst, comprising copper nanoparticles and bismuth atoms, wherein the copper nanoparticles are of a polycrystalline structure, and the bismuth atoms are dispersed in the copper nanoparticles in a single-atom form.

2. The single-atom alloy catalyst according to claim 1, wherein the bismuth atoms account for 0.9%-6.5% of a total mass of the single-atom alloy.

3. The single-atom alloy catalyst according to claim 1, wherein a diameter of the copper nanoparticles is 5 nm-20 nm.

4. A method for preparing the single-atom alloy catalyst according to any one of claims 1-3, comprising the following steps of:
(1) mixing a soluble copper salt with water, followed by adding thiourea to react, and then washing, centrifuging and drying a reactant after reaction to obtain a precursor A;
(2) mixing a soluble bismuth salt with water, followed by adding sodium diethyldithiocarbamate to react, and then washing, centrifuging and drying a reactant after reaction to obtain a precursor B;
(3) ultrasonically dispersing the precursor A and the precursor B in an alcohol solvent, and obtaining a mixed solution;
(4) heating the mixed solution obtained in step (3) to reflux, then washing, centrifuging and drying a product after reaction, and obtaining a copper sulfide precursor compounded with single-atom bismuth; and
(5) applying the copper sulfide precursor compounded with single-atom bismuth obtained in step (4) to a carbon material as an electrode to perform electrochemical reduction, and obtaining the bismuth-copper single-atom alloy catalyst.

5. The method according to claim 4, wherein the soluble copper salt comprises either of copper dichloride and copper dichloride hydrate; and
a molar ratio of the soluble copper salt to the thiourea is 1:(0.5-2), and a reaction time is not less than 10 s.

6. The method according to claim 4, wherein the soluble bismuth salt is bismuth nitrate; and
a molar ratio of the soluble bismuth salt to the sodium diethyldithiocarbamate is 1:(1-4), and a reaction time is not less than 1 min.

7. The method according to claim 4, wherein a mass ratio of the precursor A to the precursor B is 5:(1-5);
the alcohol solvent comprises ethylene glycol; and
a mass ratio of the ethylene glycol to the precursor A is (33-55):50.

8. The method according to claim 4, wherein the heating reflux is conducted at a temperature of 120° C.-130° C. for 0.5 h-4 h.

9. The method according to claim 4, wherein the copper sulfide precursor compounded with single-atom bismuth is applied to the carbon material through dripping or spraying;
the carbon material comprises any one of glassy carbon electrode, carbon paper, and carbon cloth;
the electrode is a working electrode or a cathode; and
an electrolyte for the electrochemical reduction is potassium bicarbonate or potassium hydroxide, a concentration of the electrolyte is 0.1 M-1 M, an electroreduction potential range is −0.8 V vs. RHE to −1.1 V vs. RHE, and an electroreduction reaction time is 10 min-30 min.

10. Application of the bismuth-copper single-atom alloy catalyst according to any one of claims 1-3 or the bismuth-copper single-atom alloy catalyst prepared through the method according to any one of claims 4-9 in electrochemical reduction reaction of carbon dioxide.
